(19) United States
(12) Patent Application Publication
(10) Pub. No.: US 2004/0111748 A1
(43) Pub. Date: Jun. 10, 2004

(54) System and method for search, selection and delivery of media content

(76) Inventors: Robert R. Bushey, Cedar Park, TX (US); Benjamin A. Knott, Round Rock, TX (US); William L. Reber, Rolling Meadows, IL (US)

Correspondence Address: GENERAL NUMBER 00757, BRINKS HOFER GILSON & LIONE, P.O. BOX 10395, CHICAGO, IL, 60611, US

(21) Appl. No.: 10/313,926

(22) Filed: Dec. 5, 2002

(51) Int. Cl. H04N 7/18; H04N 9/47; H04N 7/00; H04N 7/173

(52) U.S. Cl. 725/87; 725/78

(57) ABSTRACT

A method comprises receiving a video-on-demand order in which a customer non-numerically identifies a particular location in a building to receive at least one video item, and communicating the at least one video item to the particular location in the building based on the video-on-demand order.

### CROSS-REFERENCE TO RELATED APPLICATIONS

The present application is related to, and incorporates by reference, the following applications having the same assignee as the present application:

“DSL VIDEO SERVICE WITH MEMORY MANAGER”, filed on the same day as the present application, having application Ser. No. ______, (dkt. # 8285/561);

“DSL VIDEO SERVICE WITH AUTOMATIC PROGRAM SELECTOR”, filed on the same day as the present application, having application Ser. No. ______, (dkt. # 8285/564);

“DSL VIDEO SERVICE WITH STORAGE”, filed on the same day as the present application, having application Ser. No. ______ (dkt. # 8285/565); and

“SYSTEM AND METHOD FOR DELIVERING MEDIA CONTENT”, filed on the same day as the present application, having application Ser. No. ______, (dkt. # 8285/563).

### BACKGROUND OF THE INVENTION

1. Field of the Invention

The present invention relates to video distribution systems.

2. Description of the Related Art

The current approach to video and audio content selection, such as in cable television, satellite television, or an alternative content distribution system, has two dimensions: channel and time. A customer makes a selection based on a channel and a time, then watches or listens to the content identified by the channel and time. The channel typically is a discrete selection of a single channel, i.e. content is not mixed from different channels. The time typically is segmented, e.g. by 30-minute segments.

A shortcoming of the aforementioned approach is that the customer, although having control of content based on the channel and the time, has limited control of where the content is to be presented. The location where the content is presented is dictated by where a set-top box (STB) is installed. Thus, the customer is burdened to adjust his/her life schedule to meet a particular channel, particular time segments, and particular delivery points.

A couple of examples illustrate the lack of customer control. One example is a family having a discussion on blue whales during dinner. A great opportunity for the entire family to learn more about blue whales is when dinner is finished, such as approximately 6:45 P.M. Much to their disappointment, none of the channels have a show on whales this evening, let alone blue whales at 6:45 P.M. Another example is a homeowner who is building a shed in his/her backyard on a Saturday morning. The homeowner realizes that he/she does not know how to put on the roof structure. A great opportunity for the homeowner to learn more about home improvement is when he/she takes a water break. Much to his/her disappointment, none of the channels has a home improvement show on roof structures on this particular morning.

U.S. patent Application Publication No. 2001/0056350 discloses recognizing spoken commands from a cable subscriber to control the delivery of entertainment and information services, such as video-on-demand, pay-per-view, channel control, on-line shopping, and the Internet. The speech command which originates at the user site, such as the home of the subscriber, is sent upstream via the return path in the cable system to a central speech recognition and identification engine.

The determination of an associated user site may be provided by an identification within the speech channel. For example, a technician may be recognizable at many user sites, and may identify the user site as Room 432 or 10 Main Street in the process of activities at that user site.

A given residence may include more than one set-top box, each of which having a distinct address in the network delivering video content and/or cable television. Each constitutes a distinct user site and may be parameterized differently. For example, a first set-top box in a recreation area for children may allow identified users, who are children, to select programming on only certain channels. A second set-top box in a private area of adults, such as a parental bedroom, may be parameterized so that child identifier users have no privileges.

U.S. Pat. No. 6,005,861 discloses a system in which a user may choose to watch a movie from a video-on-demand service by making a selection on a hand-held remote control. A microprocessor is responsive to the selection to change the positions of switches to establish a direct circuit between a network interface unit that is connected to an external network that carries the video-on-demand service, and set-top electronics that is coupled to a television receiver on which the user desires to view the movie. With this direct circuit, data entering the home through the network interface unit is provided directly to the set-top electronics at the location where the data will be used.

U.S. Pat. No. 5,878,141 discloses an interactive television system for facilitating electronic purchases of goods and/or services. The interactive television system includes a centralized head end server which is configured to provide both television programming services and financial transaction services to multiple homes. A single head end server might be designed, for example, to service 250,000 homes. Each home may have at least set-top box coupled to at least one television, and a remote control handset. The set-top boxes are connected to receive signals from the head end server, and to control which programs are displayed on their associated televisions.

U.S. Pat. No. 6,167,443 discloses a remote video delivery system which transmits video and text from a hotel office to hotel rooms. The system relies on an identification code stored by a telephone accessory to locate a particular room in which to send information or entertainment.

U.S. Patent Application Publication No. 2001/0042249 discloses show requests that can occur in one of at least two ways. First, a user can directly request a show, such as browsing through a directory and selecting a show to request from the server. In a second method, a user can subscribe to a particular show, series of episodes, or genre of entertainment, for example. As episodes included in a subscription become available at the server-side, they are automatically delivered to the client using the client's idle bandwidth.

U.S. Pat. No. 6,353,444 discloses an auxiliary menu item that provides a preset for recording of next episode in a series.

U.S. Patent Application Publication No. 2002/0040475 discloses an electronic programming guide having enhanced functionality which includes the ability to track previously selected content so that identical or similar programs can be recorded in the future.

U.S. Patent Application Publication No. 2002/0038358 discloses a module designed to accommodate a request to add a single show. The module is used to add record events as specified after checking for conflicts or free disk space availability. Exemplary data that can be helpful in creating a data structure to be used by the module include an indicator to record all episodes and an indicator of the number of episodes.

U.S. Patent Application Publication 2002/0124249 discloses having advertisements downloaded to a set-top box. The advertisements are merged with content either dynamically during playback or by modification to the stored content to insert new advertisements.

U.S. Patent Application Publication 2002/0129375 discloses having data pre-loaded onto a set-top box. For example, short pre-loaded video clips such as movie trailers or advertisements may be displayed prior to showing a selected video. To increase the probability that a viewer will watch the trailers and advertisements, the pre-loaded trailer clips can be selected based on a subscriber's profile.

U.S. Patent Application Publication No. 2002/0052782 discloses rewarding users for viewing advertisements and for providing information about themselves. This facilitates selection and targeting of advertisements, and allows video channel viewers to subsidize and pay for the video channel programs that they are watching and the interactive video service they are using. An incentive might comprise a rate at which the buyer entity is compensated for viewing and/or interacting with advertisements. Additionally, or alternatively, it might comprise rewards that are promised to the buyer entity for responding in certain ways to these advertisements.

U.S. Patent Application Publication No. 2002/0059584 discloses content providers (broadcasters and advertisers) using usage history information to develop various content access, billing, and compensation models for consumers and content creators/owners.

U.S. Pat. No. 6,400,996 discloses interactive television advertising models wherein a user may control the content and/or commercial information received. In some cases, certain commercial sponsors may be able to avoid deletion of their advertisement, while others may allow truncation. The acceptability of this to the consumer may depend on subsidies. Instead of paying for placements directly to the media, a portion is paid to a service provider, based on consumer viewing. The media, on the other hand, may seek to adopt a pay-per-view policy, at least with respect to the service provider, in lieu of direct advertising revenues. The service provider will account to both advertisers and content providers for use. With sufficient viewing of commercials, the entire service charge for a system might be covered for a user. On the other hand, a viewer might prefer to avoid all commercials, and not get the benefit of a subsidy. In this case, the recipient may be denied a subsidy from the commercial advertiser, and pay for the privilege of commercial free content.

The service provider performs the function of delivering optimized, substituted commercials for the general commercials provided by the commercial broadcast networks, and thus can accrue profits after paying content providers a fee. An advertiser, by selecting a particular audience, may pay less than it would otherwise pay to a broadcaster. The content providers may also charge more for the privilege of use of their works.

### BRIEF DESCRIPTION OF THE DRAWINGS

The present invention is pointed out with particularity in the appended claims. However, other features are described in the following detailed description in conjunction with the accompanying drawings in which:

FIG. 1 is a flow chart of an embodiment of a method of providing a customer-in-control service;

FIG. 2 is a block diagram of a system for providing the customer-in-control service; and

FIG. 3 is a block diagram of an example of the residence of the customer.

### DETAILED DESCRIPTION OF THE PREFERRED EMBODIMENTS

Disclosed herein are embodiments of a method and system for ordering media content in which customers non-numerically identify particular locations in buildings to receive media content. The ability to control the destination location augments the ability to control the time and content, thus placing the customer in control from the beginning of the ordering process. Improving the customer control results in a better customer experience, which may promote the service as being an integral part of customers' lives.

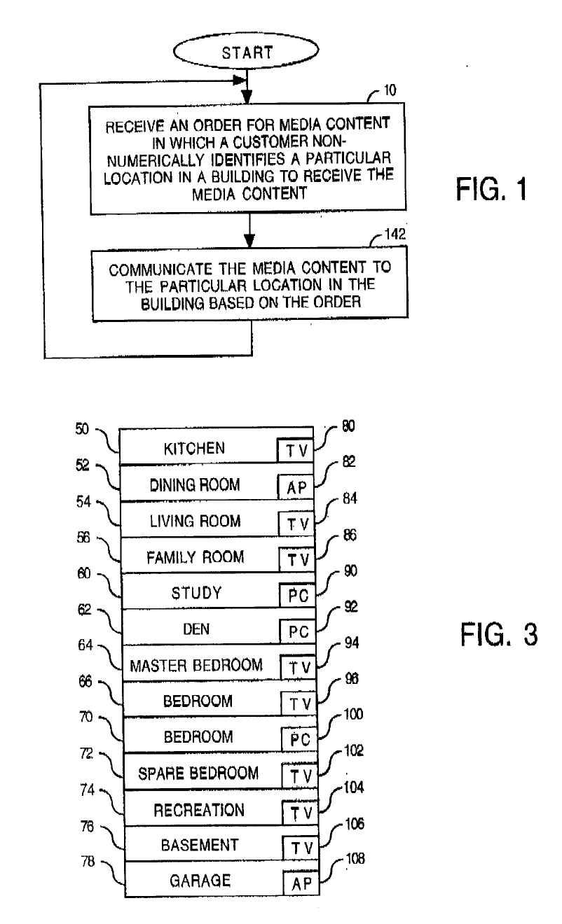

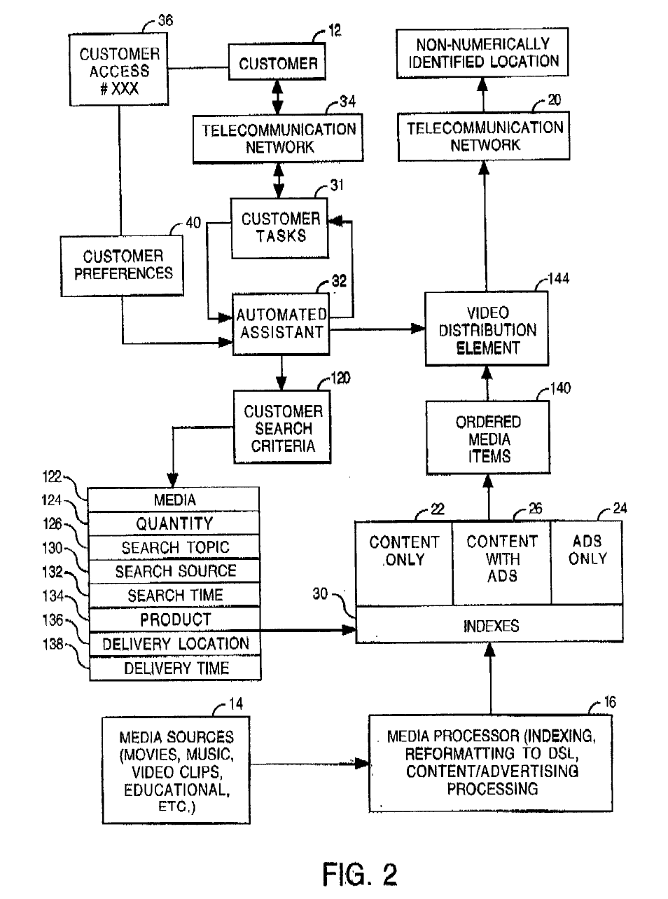

Embodiments of the present invention are described with reference to FIG. 1, which is a flow chart of an embodiment of a method of providing a customer-in-control service, and FIG. 2 which is a block diagram of a system for providing the customer-in-control service. As indicated by block 10, the method comprises receiving an order for media content (e.g. video-on-demand) from a customer 12. In the order, the customer 12 non-numerically identifies a particular location in a building to receive the media content. Examples of the building include, but are not limited to, a residence of the customer and a workplace of the customer.

The media content is selected from multiple media sources 14. Examples of the media sources include, but are not limited to, programs from broadcast television channels, programs from broadcast audio channels, movies, music, video clips, and educational videos. In general, the media content includes video content and/or audio content selected by the customer.

The media from the media sources 14 is processed by a processor 16 into a form conducive for searching, communicating via a telecommunication network 20, and selectively including advertising. In one embodiment, the processor 16 acts to reformat the media content into a digital subscriber line (DSL) format, to include indexing to facilitate searching for particular media content items, and to perform advertising processing. The result is formatted content without advertising 22, formatted targeted advertising 24, and formatted content with embedded advertising 26, all of which having associated indexes 30.

A service provider may receive revenue from customers and advertisers based on whether no advertising, embedded advertising, or targeted advertising is displayed to the customers. For example, customers may pay more for content without advertising than content with advertising, and more for targeted advertising than embedded advertising. Advertisers may pay more for targeted advertising than embedded advertising. An example of targeted advertising is providing local car advertisements to a customer who is buying a car this month.

Customer tasks 31, which include the order, are received by an automated assistant 32 via a telecommunication network 34. The automated assistant 32 may comprise an interactive voice response unit (VRU) which allows customers to place orders via a telephone network. In this case, customers can enter orders using either their voices or dual-tone multiple frequency (DTMF) signals generated by their telephone keypads. Either as an alternative to or in addition to the VRU, the automated assistant 32 may comprise a computer server which allows customers to place orders via a computer network. In this case, customers can enter orders using their computers which are connected to the computer network. Examples of the computer network include, but are not limited to, an Internet, a local area network, a digital subscriber line (DSL) network, and a cable television computer network.

Referring back to the particular customer 12, the automated assistant 32 obtains his/her customer access code 36 to facilitate creation, processing, and billing the order. Associated with the customer access code 36 is a set of customer preferences 40 specific to the customer 12. Preferably, the customer preferences 40 comprise a table of non-numeric identifiers of different locations in a building associated with the customer 12. The non-numeric identifiers may include words which the customer uses in his/her common conversations to refer to locations in the building. For purposes of illustration and example, consider the building associated with the customer 12 being his/her place of residence, such as a house or an apartment. In this case, the customer preferences 40 may comprise a table including names of rooms in the residence. The names of the rooms non-numerically identify locations of different media players in the residence. Each of the media players can receive media content via the telecommunication network 20. Examples of the media players include, but are not limited to, a video player such as a television (TV) with or without a set-top box, an audio player, and a personal computer (PC).

FIG. 3 is a block diagram of an example of the residence of the customer 12. The residence has a plurality of rooms comprising a kitchen 50, a dining room 52, a living room 54, a family room 56, a study 60, a den 62, a master bedroom 64, a son's bedroom 66, a daughter's bedroom 70, a spare bedroom 72, a recreation room 74, a basement 76, and a garage 78. Each of the rooms has a media player capable of receiving and audibly and/or visually displaying content received via the telecommunication network 20. For example, the kitchen 50 may have a TV 80, the dining room 52 may have an audio player 82, the living room 54 may have a TV 84, the family room 56 may have a TV 86, the study 60 may have a PC 90, the den 62 may have a PC 92, the master bedroom 64 may have a TV 94, the son's bedroom 66 may have a TV 96, the daughter's bedroom 70 may have a PC 100, the spare bedroom 72 may have a TV 102, the recreation room 74 may have a TV 104, the basement 76 may have a TV 106, and the garage 78 may have an audio player 108.

In this example, the customer preferences 40 include a table 110 indicating how the customer 12 wishes to non-numerically identify each of the rooms. For example, the customer 12 may wish to identify the kitchen 50 as “kitchen”, the dining room 52 as “dining room”, the living room 54 as “living room”, the family room 56 as “family room”, the study 60 as “study”, the den 62 as “den”, the master bedroom 64 as “master bedroom”, the son's bedroom 66 as “John's room”, the daughter's bedroom 70 as “Jane's room”, the spare bedroom 72 as “spare bedroom”, the recreation room 74 as “rec room”, the basement 76 as “basement”, and the garage 78 as “garage”.

More generally, the customer 12 can non-numerically identify a particular location using a possessive in combination with a room. The possessive may comprise the word “my” such as in “my room”, “his” such as in “his office”, “her” such as in “her office”, “our” such as in “our bedroom”, an individual's name such as in “John's room”, “boys'” such as in the “boys' room”, or “girls'” such as in the “girls' room”.

In general, the automated assistant 32 identifies the particular location spoken or otherwise entered by the customer 12 using the non-numeric names stored in the customer preferences 40. Thus, if the automated assistant 32 comprises a VRU, the customer 12 can vocally say “spare bedroom” to indicate that the spare bedroom 72 is an intended destination location to display ordered media content. If the automated assistant 32 comprises a computer server, the customer 12 can either type or select “John's room” to indicate that the son's bedroom 66 is an intended destination location to display ordered media content.

Referring back to FIG. 2, the automated assistant 32 interacts with the customer 12 to form customer search criteria 120 to assist in searching for specific media content. Examples of data elements in the customer search criteria 120 include, but are not limited to, a media element 122, a quantity element 124, a search topic element 126, a search source element 130, a search time element 132, and a product element 134. The media element 122 characterizes the media content, such as being either a television show, a sporting event, or an order for a product. If the media element 122 indicates an order for a product, the product element 134 identifies the product. The quantity element 124 indicates how many items (e.g. either media or products) are being ordered. The search topic element 126 indicates a general topic which describes the media content. The search source element 130 indicates a source which provides the media content, such as a particular television channel. The search time element 132 indicates a time period within which the media content was either broadcast or originally produced.

The data elements also include a delivery location element 136 and a delivery time element 138. The delivery location element 136 indicates where the items (e.g. either media or products) are to be delivered. For media content, the delivery location element 136 is based on the customer's non-numeric identification of a particular location in a building. The delivery time element 138 indicates when the items (e.g. either media or products) are to be delivered. For example, the customer 12 may place a video-on-demand order which comprises a delivery time indicating when he/she wants to the receive at least one video.

The customer search criteria 120 may be based on the customer preferences 40. For example, the customer preferences 40 may comprise a viewing/hearing history of content previously watched/heard by the customer 12. Customers may pay a premium to have a “previously-watched” capability which uses the viewing/hearing history in customer search criteria 120. This capability allows customers to filter out previously-watched content, for example.

The automated assistant 32 may interact with the customer 12 in a question-and-answer session to elicit all of the information needed to identify one or more particular media content items 140, a delivery location, and a delivery time. Further, the customer 12 may indicate whether he/she chooses to have advertisements embedded with the particular media content items 140. Thereafter, as indicated by block 142 in FIG. 1, the particular media content items 140 (e.g. at least one video item) in the order are transmitted by a video distribution element 144 via the telecommunication network 20 to the customer's particular delivery location at the particular delivery time. In one embodiment, the particular media content items 140 are transmitted to the customer 12 via a DSL network.

Although illustrated for a single customer, those having ordinary skill will recognize that the teachings herein apply to multiple customers at multiple locations. Each of the customers has his/her own access code and associated set of customer preferences. The customer preferences will reflect each residential customer's own unique way of referring to rooms or locations in his/her residence. For example, consider a set of houses having the same floor plan. A common room in each of the houses may be referred to differently by different residential customer-some may refer to the room as a “study” and others may refer to the room as a “den”. A common bedroom in each of the houses may be referred to as either a “spare bedroom”, “my bedroom”, or “Joe's room” dependent upon the customer.

Five examples of dialog between customers and the automated assistant 32 follow for purposes of illustration. In these examples, the automated assistant 32 is embodied by a VRU to allow customers to place orders using their telephones. In addition to the dialog, various data elements used by the automated assistant 32 to search for content and specify parameters of the orders are shown.

### EXAMPLE DIALOG 1

### Entertainment

Automated Assistant (AA): “Hi. SBC's automated assistant, how may I help you?”

Parent (P): “I want to schedule a show today about blue whales.” (Data elements: media=show, quantity=1, search topic=blue whales, search source=Discovery Channel, search time period=2 weeks, delivery location=unspecified, delivery time=unspecified.)

AA: “Just a minute, let me look. (Pause) I found a 30 minute show that was on Discovery channel two weeks ago titled ‘Blue Whales in the Pacific Ocean’. Is this the show you wish?”

P: “Yes, thanks. I would like to begin in ten minutes.” (Data element: show=“Blue Whales in the Pacific Ocean”.)

AA: “OK, 10 minutes or at 6:40. Where do you want them delivered?” (Data element: delivery time=6:40 P.M.)

P: “The big screen TV in the family room.”

AA: “Will do. Is there anything else?” (Data element: delivery location=family room TV.)

P: “No, thanks for your help.”

AA: “You are welcome. Goodbye.”

### EXAMPLE DIALOG 2

### Building Project

AA: “Hi. SBC's automated assistant, how may I help you?”

P: “How do I put a roof on my shed?” (Data elements: media=show, quantity=1, search topic=how to put on a roof, search source=default to 40 most popular channels since channel is unspecified, search time period=default to 8 weeks since time period is unspecified, delivery location=unspecified, delivery time=unspecified.)

AA: “Just a minute, let me look for information. (Pause) I found a 15 minute movie that was on Do-It-Yourself Channel three weeks ago titled ‘Building Sheds’. Is this the movie you wish?”

P: “Maybe. Is there another movie that covers this topic?”

AA: “Just a minute, let me look. (Pause) I found another 15 minute movie that was on Do-It-Yourself Channel six weeks ago titled ‘Roofing for Dummies’. Is this the movie you wanted?”

P: “Yes, that sounds much better.” (Data element: show #1=“Roofing for Dummies”.)

AA: “Do you want to schedule this ‘Roofing for Dummies’ movie?”

P: “Yes, I would like to see that movie now.”

AA: “OK, it will take about a minute to get it started, so it will begin at 9:51. Where do you want them delivered?” (Data element: delivery time=9:51 A.M.)

P: “The TV in the kitchen.” (Data element: delivery location=kitchen TV).

AA: “Will do. Is there anything else?”

P: “No, that's it.”

AA: “Goodbye.”

### EXAMPLE DIALOG 3

### Ordering

AA: “Hi. SBC's automated assistant, how may I help you?”

Homeowner (H): “I need one-inch galvanized roofing nails.” (Data elements: media=ordering, quantity=1, product=nails, source=Lowe's, order time period=1 hour, delivery location=pick up at store.)

AA: “I will send Lowe's that order for one-inch galvanized nails. I assume you want to order at the Lowe's store located at the corner of 620 and 183, right?”

H: “Yes.” (Data element: store location=Lowe's at 620 and 183.)

AA: “Do you want the one-pound box or the five-pound box?”

H: “The one-pound box.” (Data element: product size=one-pound box.)

AA: “Just a minute, let me send that order. (Pause) Lowe's just confirmed that they received the order and that you wanted to pick it up later this morning. Is there anything else?” (Data element: order status=Lowe's confirmed with confirmation number 123456.)

H: “Nope.”

AA: “Goodbye.”

### EXAMPLE DIALOG 4

### Previously Watched

AA: “Hi. SBC's automated assistant, how may I help you today?”

H: “I would like to continue watching the ‘Law and Order’ series. Please have the next show on my kitchen TV in about ten minutes.” (Data elements: media=ordering, quantity=1, product=Law & Order, source=A&E Channel, date=today, time period=10 minutes, delivery location=kitchen TV.)

AA: “Just a minute, let me get that episode for you. (Pause) I found it. You are up to the eighth episode in this series. I will show that episode on your kitchen TV at 7:12, OK?”

H: “Yes.” (Data elements: delivery time=7:12 PM, episode=8).

AA: “Is there anything else?”

H: “Nope.”

AA: “Goodbye.”

### EXAMPLE DIALOG 5

### Multi-Modal

AA: “Hi. SBC's automated assistant, how may I help you today?”

H: “I would like to watch a college football game today. What games were played yesterday or today?” (Data elements: media=sports, quantity=1, product=college football game, source=unspecified, date today or yesterday.)

AA: “Just a minute, let me look for you. (Pause) There were quite a few games played on Saturday and a few today, Sunday. I will show you the list of these games on one of your PC's, OK?”

H: “Yes.” (Data element: monitor=PC.)

AA: “OK, the PC. How do you want the games sorted: by date/time or by region?”

H: “By region.” (Data element: sort=region.)

AA: “OK, do you see the list?”

H: “Yes. I would like to see the Texas versus Oklahoma game on the family room TV in 30 minutes.” (Data elements: game=TX vs OK, time=30 minutes, delivery location=family room TV.)

AA: “OK, the Texas versus Oklahoma game on your family room TV at 2:45 P.M., right?”

H: “Yes, thanks.” (Data element: delivery time=2:45 P.M.)

AA: “By the way, Pizza Hut has a large cheese pizza for only $8.00. Would you like that delivered?”

H: “Yes, thanks.” (Data element: product=Pizza Hut large cheese-pizza.)

AA: “So, Pizza Hut will deliver a large cheese pizza for $8.00 in 30 minutes to your home, correct?”

In summary, the system described herein is able to gather and understand customer tasks, search a content database through indexes to locate particular content items, and deliver the particular content items to a customer's desired location (e.g. a personal computer in the study or the family room TV set). The system may use more than one modality to interact with the customer, e.g. using audio over a telephone and visual over a personal computer. This is particularly important for long lists of information, previewing video files, and other audio/visual situations.

The system has the ability to collect and save customer preferences. The system is further able to automatically update the customer's history as to previously viewed/listed content. Customer search criteria may be captured and retained by the system.

The system can separate content from advertising. For example, a show such as Law & Order can be stored separately from embedded advertisements. The customer can choose how they want to view a particular show: either with embedded advertisements (having a low cost to the customer), without embedded advertisements (having a higher cost to the customer), or with targeted advertisements based on customer preferences (higher cost to the advertiser). In addition to being based on customer preference, the targeted advertisements may be based on the content they are currently viewing and the customer's location.

It will be apparent to those skilled in the art that the disclosed inventions may be modified in numerous ways and may assume many embodiments other than the preferred forms specifically set out and described herein.

Accordingly, it is intended by the appended claims to cover all modifications which fall within the true spirit and scope of the present invention.

What is claimed is:

1. A method comprising:
receiving a video-on-demand order in which a customer non-numerically identifies a particular location in a building to receive at least one video item; and
communicating the at least one video item to the particular location in the building based on the video-on-demand order.

2. The method of claim 1 wherein the video-on-demand order has a specific delivery time, and wherein said communicating the at least one video item to the particular location in the building is based on the specific delivery time.

3. The method of claim 1 wherein the video-on-demand order is received in at least two modes comprising a telephone mode and a computer mode.

4. The method of claim 1 wherein the customer vocally identifies the particular location in the video-on-demand order.

5. The method of claim 1 further comprising providing customer preferences which include non-numeric names of locations in the building, and identifying the particular location using the customer preferences.

6. The method of claim 5 wherein the building comprises a residence of the customer, and wherein the non-numeric names comprise at least two of a family room, a bedroom, a living room, a kitchen, and a dining room.

7. The method of claim 1 wherein the customer non-numerically identifies the particular location using the word “bedroom”.

8. The method of claim 7 wherein the customer non-numerically identifies the particular location using an individual's name in addition to the word “bedroom”.

9. The method of claim 7 wherein the customer non-numerically identifies the particular location using the phrase “spare bedroom”.

10. The method of claim 7 wherein the customer non-numerically identifies the particular location using the phrase “master bedroom”.

11. The method of claim 1 wherein the customer non-numerically identifies the particular location using a possessive with a room.

12. The method of claim 11 wherein the possessive comprises “my”.

13. The method of claim 11 wherein the possessive comprises an individual's name.

14. The method of claim 1 wherein the customer non-numerically identifies the particular location using the phrase “family room.”

15. The method of claim 1 wherein the customer non-numerically identifies the particular location using the phrase “living room”.

16. The method of claim 1 wherein the customer non-numerically identifies the particular location using the phrase “dining room”.

17. The method of claim 1 wherein the customer non-numerically identifies the particular location using the word “kitchen”.

18. The method of claim 1 wherein the customer non-numerically identifies the particular location using the word “garage”.

19. The method of claim 1 wherein the customer non-numerically identifies the particular location using the word “basement”.

20. The method of claim 1 wherein the at least one video item is communicated to the particular location in the building via a digital subscriber line.

21. A method comprising:
providing customer preferences which include non-numeric names of locations in a residence of a customer, the non-numeric names comprising at least two of a family room, a bedroom, a living room, a kitchen, and a dining room;
receiving a video-on-demand order in which the customer non-numerically identifies a particular location in a residence to receive at least one video item at a specific delivery time;
identifying the particular location using the customer preferences; and
communicating, via a digital subscriber line, the at least one video item to the particular location in the residence at the specific delivery time based on the video-on-demand order.

22. A system comprising:
an automated assistant to interact with a customer to receive a video-on-demand order in which the customer non-numerically identifies a particular location in a building to receive at least one video item; and
a video distribution element responsive to the automated assistant to communicate the at least one video item to the particular location in the building based on the video-on-demand order.

23. The system of claim 22 wherein the video-on-demand order has a specific delivery time, and wherein said video distribution element is to communicate the at least one video item to the particular location in the building is based on the specific delivery time.

24. The system of claim 22 wherein the automated assistant comprises a computer server to receive video-on-demand orders in a computer mode and an interactive voice response unit to receive video-on-demand orders in a telephone mode.

25. The system of claim 22 wherein the automated assistant comprises an interactive voice response unit to receive from the customer a vocal identification of the particular location in the video-on-demand order.

26. The system of claim 22 further comprising customer preferences data which include non-numeric names of locations in the building, wherein the automated assistant is to identify the particular location using the customer, preferences.

27. The system of claim 26 wherein the building comprises a residence of the customer, and wherein the non-numeric names comprise at least two of a family room, a bedroom, a living room, a kitchen, and a dining room.

28. The system of claim 22 wherein the video distribution element is to communicate the at least one video item to the particular location in the building via a digital subscriber line.
